(19) United States
(12) Patent Application Publication
(10) Pub. No.: US 2004/0069169 A1
(43) Pub. Date: Apr. 15, 2004

(54) Device for flexographic printing of security documents and resulting documents

(76) Inventors: Florian Demaimay, Nantes (FR); Rene Loury, Betton (FR)

Correspondence Address: JACOBSON HOLMAN PLLC, 400 SEVENTH STREET N.W., SUITE 600, WASHINGTON, DC, 20004, US

(21) Appl. No.: 10/450,846

(22) PCT Filed: Dec. 20, 2001
(86) PCT No.: PCT/FR01/04105

(30) Foreign Application Priority Data
Dec. 26, 2000 (FR) 00/17019

(51) Int. Cl. B41F 13/24

(52) U.S. Cl. 101/232

(57) ABSTRACT

The invention concerns a sheet-by-sheet flexographic printing device of safety documents, comprising means for transferring (2) said sheets (F), successively, from a supply station (1) located upstream, to a storage and removal station (6) located downstream, via at least a flexographic printing station (3) adapted to process the front surface of said sheets called first station. The invention is characterised in that the device also comprises at least a flexographic printing station (4), called second station , adapted to process the back surface of said sheets (F) during their transfer from upstream to downstream, without having to grasp them and modify their orientation between the two stations, said two stations being separated by at least two intermediate cylinders (22, 23) and said second printing station (4) is offset in height relative to the first (3), such that when they are transferred from one to the other, the sheets (F) are imparted an upward trajectory. The invention also concerns the security documents obtained by using such a device.

The present invention relates to a sheet-fed press for flexographic printing of security documents.

It also relates to a security document obtained with the aid of this kind of press.

The expression “security document” means any document having a fiduciary and/or official value delivered by a state, an agency of a state, or a private enterprise such as a bank.

Examples of such documents include banknotes or bills, paper for use in making up passports, identity cards, checks, etc.

In the particular field of banknotes, the printed documents are subject to severe and varied external constraints.

There is therefore a requirement for various means of augmenting their service life.

One proposed solution is to use new media obtained either by substituting synthetic polymers for some or all of the natural fibers that traditionally constitute the paper medium or by applying a polymer layer to the surface of the paper.

This considerably improves the mechanical properties of the medium.

However, the durability of printing on such media, especially when using intaglio ink, is sometimes problematic and often becomes the limiting factor in the durability of the banknote in circulation.

Furthermore, the security of banknotes is a question with which fiduciary printing works are ceaselessly confronted in that they are always confronted with a situation of constantly increasing counterfeiting. Printing methods using liquid inks are relatively little used in the field of security printing except, with a few exceptions, for screenprinting.

Liquid security inks have nevertheless been developed and include optical effect inks, metallic inks, luminescent inks and iridescent inks.

This development is justified by the encouraging results obtained, as much for the visual and security aspects as for that of long life (and thus the durability and security of the banknote).

Moreover, including different printing methods in the overall banknote fabrication process faces counterfeiters with a further problem and contributes to the security of the banknote.

It is in this field of printing that the present applicant aims to extend the life of security documents and to make their reproduction complicated if not impossible.

There has previously been proposed a method of flexographically coating paper that has proven particularly beneficial in terms of durability.

However, applying the coating has required the sheets just coated on one side to be picked up one by one, turned over, and fed again into the same flexographic printing station or into a further station.

That kind of technique is particularly constraining because the sheets have to be allowed to dry before they are turned over. Such handling also introduces the risk of causing registration errors for the second printing on the sheets.

The document EP-A-0 976 555 describes a press for printing the fronts and the backs of sheets without turning them over. The press includes an upper roll followed in the direction of movement of the sheets by an adjacent lower roll. Each roll is associated with a printing unit and/or the whole or part of a drying unit. The two rolls constitute a module that can be repeated a number of times.

The disposition of two adjacent rolls in each module leaves only a very limited space for a dryer on each roll, downstream of the printing unit. This implies that it is necessary to provide additional dryers on additional rolls disposed at the end of the press.

Furthermore, that solution limits the thickness of the coating applied by each printing unit. A thicker coating would not have time to dry, given the very short time and the limited drying possibilities before it reaches the next printing stage. If the problem is not solved, there arise problems of set-off (when some ink is transferred to the adjacent printing roll).

That solution appears to be reliable for offset printing, in which the layer of ink deposited is thin (of the order of a few microns thick). For flexographic coating, the deposition process has to be divided into a plurality of stages using a plurality of modules. This explains why at least two modules are assigned to coating each sheet in the solutions proposed in the above document.

Moreover, the arrangement of the rolls in the form of modules comprising two units is unsuitable if the treatment to be applied to the fronts of the sheets is different from that to be applied to the backs. Thus in theory four rolls, each associated with a respective printing unit, are necessary if it is required to apply three different colors to one side and only one color to the other side. In practice, it is then necessary to use three modules, that is to say six rolls, of which only four in fact carry out an operation.

Finally, the linear disposition of the rolls imposes a virtually identical height above the floor for all the printing units. However, in that case, it is difficult to obtain easy access both to the upper printing units and to the lower printing units. Thus if sufficient access is provided for operatives to work easily on the lower units, the upper units are too high up to be easily accessible. The converse situation is also encountered. Another solution is to provide an access pit for the lower units, which requires serious civil engineering works. This is burdensome and costly, and does nothing to facilitate subsequent relocation of the press.

Thus an object of the present invention is to propose a sheet-fed press for flexographic printing of security documents that alleviates the above-mentioned drawbacks.

In other words, this press provides the time and the space necessary for the ink or the coating to dry between the front and back printing stations. Moreover, it accommodates a large number of printing station configurations, on the assumption that the operations to be applied to the fronts of the sheets are different from those to be applied to the backs. What is more, a press of this kind provides sufficient room to assure easy access to the various printing stations.

Against this background, the present invention proposes a sheet-fed press for flexographic printing of security documents, which press comprises means for transferring successive sheets from an upstream feeder station to a downstream offloading and storage station via one or more flexographic printing stations each adapted to treat the fronts of said sheets and referred to as a “first station”.

The press is essentially characterized in that it further comprises one or more flexographic printing stations each referred to as a “second station” and each adapted to treat the backs of said sheets during their transfer from the upstream end to the downstream end of the press without having to take them up and invert their orientation between the two stations, which are separated by two or more intermediate rolls, and in that said second printing station is offset in height relative to said first printing station so that the sheets follow an upward trajectory during their transfer from one station to the other.

By “printing” is meant applying to the sheets either inks for producing thereon diagrams or alphabetic or numeric characters or a material such as a coating.

The expression “without having to take them up and invert their orientation” means that the sheets are fed from the upstream end to the downstream end and through the two flexographic printing stations without any manual or mechanical intervention to take them up one by one and turn them over.

Thus it is possible to treat the fronts and backs of the sheets without having to manipulate them, in this instance turn them over, between the two stations.

Moreover, according to other advantageous but non-limiting features of the above press:

said first station includes means for printing while the paper is moving downwards and said second station includes means for printing while the paper is moving upwards;

the second station is offset longitudinally relative to said first station;

said printing station for printing the fronts of said sheets is nearer the feeder station;

it includes a space for access to the or each of said second stations adapted to allow an operative to monitor its correct operation visually;

it includes a trolley for transporting the printing roll of the or each of said second stations for loading and/or maintenance.

The invention also provides a security document obtained with the aid of a press having any one of the features referred to above.

In a preferred embodiment, the document in question is a banknote.

Other features and advantages of the present invention will become apparent on reading the following description of a preferred embodiment of the invention.

The description refers to the appended drawings, in which:

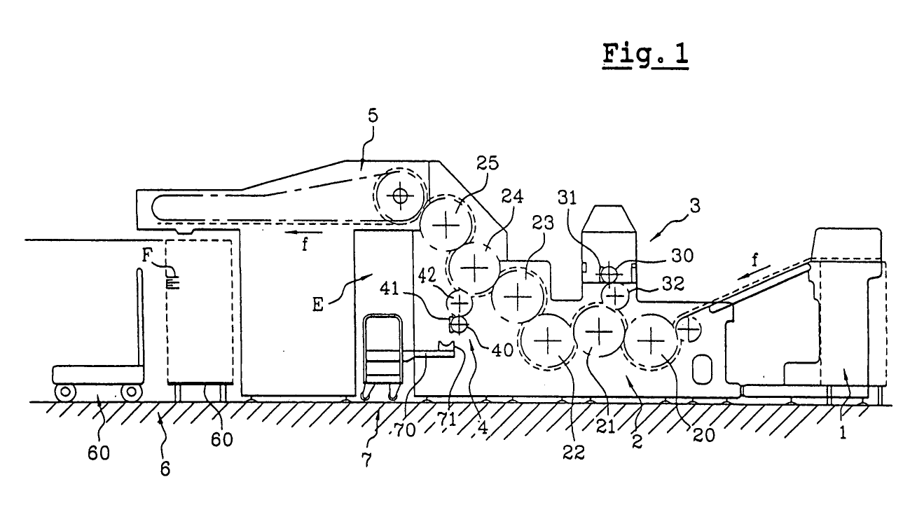

FIG. 1 is a highly diagrammatic representation of a flexographic printing press in accordance with the invention seen from the side; and

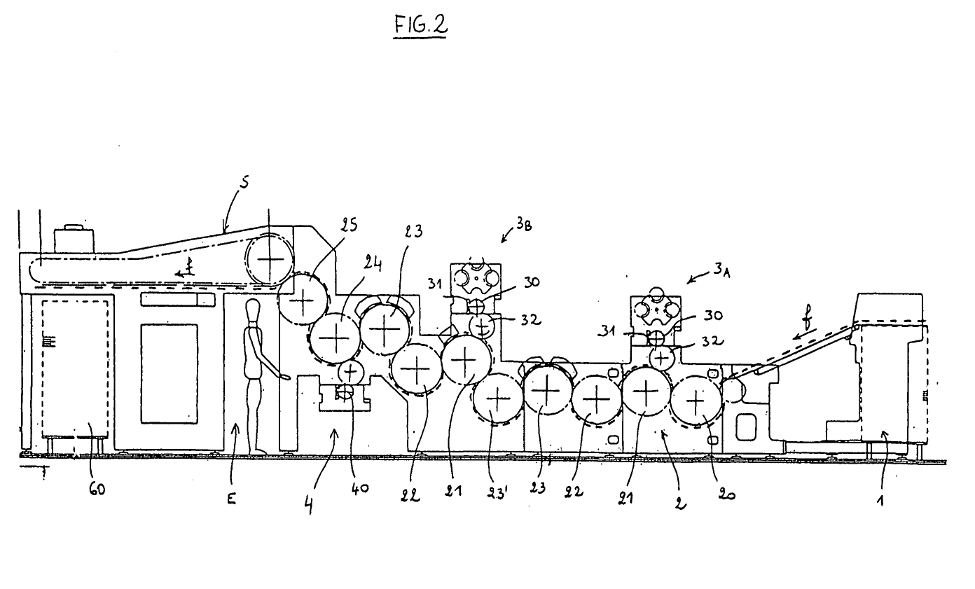

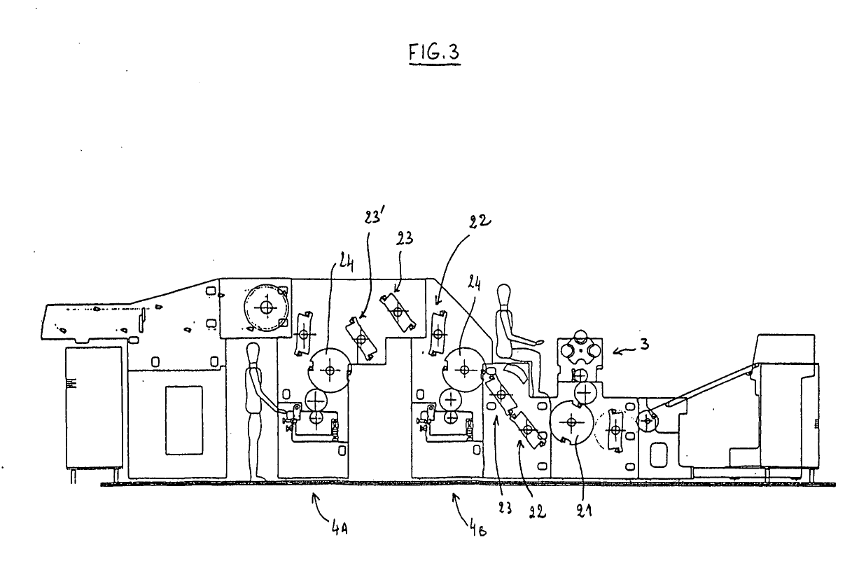

FIGS. 2 and 3 are diagrammatic side views of two other embodiments of the press.

The sheet-fed flexographic printing press shown in the appended FIG. 1 can be used either for coating security documents or for printing characters or diagrams on security documents.

The following description refers by way of example to the treatment of the sheets in order to produce large sheets of banknotes. The description is nonetheless valid for other types of security document.

The diagram shows in dashed line the displacement in the direction of an arrow f of sheets to be printed to constitute large sheets of banknotes. The sheets are moved from an upstream end to a downstream end of the press that are respectively on the right-hand side and on the left-hand side of FIG. 1.

Firstly, the printing press comprises a feeder station 1 at its upstream end at which the sheets to be treated are stored. Where appropriate, the sheets have been printed beforehand using other techniques.

This station comprises means for feeding the sheets one by one towards a first transfer roll 20. These means, which are not shown in the figure, consist of a conveyor belt, for example. The roll 20 is coupled to an impression roll 21. These first two rolls are part of a set 2 of six rolls with parallel and horizontal rotation axes.

Of course, the dimensions of the sheets and the diameters of the rolls are such that the sheets are fed without problems, i.e. without any risk of them separating from a roll and dropping to the floor.

The drive means of the rolls, for example electric motors, are not shown.

The first flexographic printing station 3 is in the vicinity of the upper part of the roll 21. The coating or ink to be applied to the sheets is collected from a chamber 31 fitted with a doctor blade by a cellular roll 30 known to the person skilled in the art as an “anilox” roll, and is then transferred to the sheet by a printing plate or blanket fixed to the periphery of an intermediate roll 32 that cooperates with the roll 21.

The fronts of the sheets are coated or printed in the first flexographic printing station.

On leaving the roll 21, the sheets are taken up by a pair of intermediate rolls 22 and 23, of which the second is higher than the first. In the example described here, two intermediate rolls are shown. In a different embodiment there could be a greater number of intermediate rolls.

The intermediate rolls are preferably hollow, i.e. essentially comprise two parallel metal disks connected by rods extending along generatrices of said roll. Means such as clamps grasp the sheets.

The intermediate rolls ensure optimum drying of the sheets on leaving the first flexographic printing station 3, even if there is considerable deposition thereon, without risk of set-off to the next printing roll. Drying is faster if these rolls are hollow.

To improve and further accelerate the drying of the deposit on the upper side of the paper, dryers, not shown, are disposed in the vicinity of the rolls 22 and 23, for example.

At this stage of the process the paper moves upwards.

The press also includes a new impression roll 24 and a transfer roll 25. The second flexographic printing station is in the lower part of the roll 24.

In a similar manner to what happens at the first station, coating or ink is taken up from a chamber 41 fitted with a doctor blade by an anilox roll 40 and (in this example) transferred to the back of the paper by a printing plate or blanket fixed to a roll 42.

The rolls 24 and 25 are again at different heights above the floor, so that the sheets travel upwards as they move from the first flexographic printing station to the exit of the second station.

This makes the press more compact in the direction of displacement of the sheets, since the overall longitudinal space taken up by the rolls 20 to 25 is less than the sum of their diameters.

The station 3 prints while the paper is moving downwards and the station 4 prints while the paper is moving upwards. This further improves the compactness of the press.

The transfer roll 25 delivers the sheets treated on both sides to a conveyor belt 5 which feeds the treated sheets to a take-off and storage station 6 which is equipped with trolleys 60 adapted to receive a stack of treated sheets F, for example.

Of course, drying machines, not shown, are provided at the exit from the second flexographic printing station to dry the deposit on the lower side of the paper.

It will be noted that the upward movement of the paper between the two stations, in addition to making the press more compact in the direction of displacement of the sheets, provides a space E under the press enabling an operative to monitor the progress of printing and more particularly the printing of the backs of the sheets.

This space can accommodate a trolley 7 with mobile arms 70 adapted to receive the roller 40 in a trough 71 provided for this purpose, for servicing or changing it.

This avoids the need for serious civil engineering works to provide access to the lower printing unit.

FIG. 2 shows a press in accordance with the invention for applying two different printing operations to the fronts of the sheets and only one printing operation to the backs.

Components in this figure similar or identical to components already described with reference to FIG. 1 are identified by the same reference number.

Thus there are two front printing stations 3A and 3B with transfer rolls 22, 23 and 23′ between them. The number of transfer rolls is odd so that the station 3B can print on the backs of the sheets.

The back printing station 4 is separated from the unit 3B by two transfer rolls 22 and 23 and is offset in height relative to the station 3B.

This makes the press more compact and provides a space E for access to the station 4. Moreover, no supernumerary rolls are used.

FIG. 3 shows a press for carrying out one printing operation on the fronts of the sheets and two printing operations on the backs. It shows a front station 3 and two back stations 4A and 4B. In this figure, the hollow transfer rolls, including the rolls 22 and 23, have been shown in a different manner to the impression rolls 21 and 24 associated with the printing stations.

As already stated, the printing press of the invention can be used either to coat sheets or to produce diagrams or characters.

With regard to coating, the solution adopted to increasing the durability of banknotes in circulation is double-sided overprinting of a coating on said banknotes.

This significantly increases the durability of the banknotes in circulation. It also improves the protection of the graphic elements through the combined effect of excellent adhesion of the ink, which is associated with the fibrous surface of the paper, and the formation of a protective coating on top of the film of ink.

Finally, this technique conserves all of the traditional paper security features, in particular the watermark.

By means of the invention, the deposition of the coating is controlled to achieve optimum efficiency of transfer by appropriately adjusting the volume of the alinox rolls, the ink chamber with its doctor blade, and the plate.

These elements have a direct influence on the effectiveness of the protection obtained.

A water-based acrylic coating is entirely suitable and also has advantages in terms of protection of the environment.

Banknotes treated in this way are significantly improved compared to uncoated prior art banknotes.

For example, it is found that notes coated in this way absorb much less water. Water contributes to premature aging of banknotes through hydrolysis of the bonding between the cellulose fibers. Consequently, coating improves the durability of the mechanical properties of the medium.

A reduction in permeability to air of the order of 25 to 30% is also obtained, providing real protection against the effects of moisture in the air.

Coating also contributes to improved durability of luminescent inks, even if the note has unfortunately been exposed to hot water, possibly with a detergent added to it.

The coating also has excellent resistance to chemical agents and improves the abrasion resistance of the banknote by approximately 50%.

Finally, the coating significantly increases the protection of the banknote against soiling, by forming a screen against soiling.

If the invention is used to print diagrams or lines of text, different types of water-based, solvent-based or UV-dried liquid inks can be used. The invention allows the use of hot air drying, infrared drying or ultraviolet drying. Drying by a combination of these techniques can also be used.

The liquid inks that can be used include security inks, such as OVI (Registered Trade Mark) inks and iridescent, phosphorescent, metallic and magnetic inks.

The high quality of front to back registration can also be exploited to achieve novel effects.

1. A sheet-fed press for flexographic printing of security documents, which press comprises means (2) for transferring successive sheets (F) from an upstream feeder station (1) to a downstream offloading and storage station (6) via one or more flexographic printing stations (3) each adapted to treat the fronts of said sheets and referred to as a “first station”, which press is characterized in that it comprises one or more flexographic printing stations (4), each referred to as a “second station” and each adapted to treat the backs of said sheets (F) during their transfer from the upstream end to the downstream end of the press without having to take them up and invert their orientation between the two stations, which are separated by two or more intermediate rolls (22, 23, 23′), and in that said second printing station (4) is offset in height relative to said first printing station (3) so that the sheets (F) follow an upward trajectory during their transfer from one station to the other.

2. A press according to claim 1, characterized in that said first station (3) includes means for printing while the paper is moving downwards and said second station (4) includes means for printing while the paper is moving upwards.

3. A press according to claim 1 or claim 2, characterized in that said second station (4) is offset longitudinally relative to a first station (3).

4. A press according to claim 3, characterized in that the or each of said first printing stations (3) is nearer the feeder station (1).

5. A press according to any of claims 1 to 4, characterized in that it includes a space (E) for access to the or each of said second stations (4) adapted to allow an operative to monitor its operation visually.

6. A press according to any one of claims 1 to 5, characterized in that it includes a trolley for transporting the printing roll (40) of the or each of said second stations (4) for loading and/or maintenance.

7. A security document obtained with the aid of the press according to any one of claims 1 to 6.

8. A security document according to claim 7, characterized in that it constitutes a banknote.
